(19) United States
(12) Patent Application Publication
(10) Pub. No.: US 2017/0033808 A1
(43) Pub. Date: Feb. 2, 2017

(54) REAL-TIME NETWORK ANALYZER AND APPLICATIONS

(71) Applicant: VAYYAR IMAGING LTD., Yehud (IL)

(72) Inventors: Yuval LOMNITZ, Yehud (IL); Naftali CHAYAT, Yehud (IL)

(21) Appl. No.: 15/226,865

(22) Filed: Aug. 2, 2016

Related U.S. Application Data
(60) Provisional application No. 62/200,079, filed on Aug. 2, 2015.

(51) Int. Cl. H04B 1/00; H04B 17/309; H04B 1/10; H04W 24/08

(52) U.S. Cl. CPC H04B 1/0092; H04W 24/08; H04B 17/309; H04B 1/1018

(57) ABSTRACT

In some applications network parameters vary over time in a manner that precludes the use of conventional swept frequency network analyzers. Swept measurements incur penalty both in terms of acquisition time, and in terms of registration between measurements taken at the beginning and at the end of a sweep. The invention presents an architecture for real-time analysis of network parameters. Example applications are presented, ranging from thermal drift of amplifiers, to microwave imaging of moving objects, to characterizing materials on conveyors, to characterizing plasma buildup, and many more.

### CROSS-REFERENCE

The present application claims the benefit of U.S. Provisional Application Ser. No. 62/200,079, filed on Aug. 2, 2015, entitled “REAL-TIME NETWORK ANALYZER AND APPLICATIONS” (attorney docket no. VY021/USP), the entire disclosures of which are incorporated herein by reference.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

Network analyzers are an essential tool for characterizing radio frequency devices. Network analyzers are often embedded into systems for characterizing antennas, radar cross section, propagation paths, materials sensors etc. The common structure of a network analyzer is a frequency-stepped signal source, and multiple receivers, at least one of which measures a reference signal, and at least one simultaneously measures the signal arriving from the device under test (DUT). The dwell time on each frequency depends on the amount of signal averaging desired, affecting the measurement accuracy and sensitivity, and it is reflected in a “IF bandwidth” or “resolution bandwidth” parameter. The number of frequencies over which the sweep is performed affects the overall sweep time.

The DUT parameters are usually assumed to remain constant throughout the sweep time. In most applications this does not pose a limitation, such as when characterizing passive networks, e.g. filters. However, in many cases, the network parameters change over time. For example, an antenna may rotate in an antenna range. An amplifier may warm up and change its characteristics after turn-on. Material under test may move on a conveyor belt or in a pipe, each time bringing in a new sample. A patient may breath or move during examination in a medical microwave imaging system. An indoor propagation path may vary due to plasma discharge buildup and decay in a fluorescent lamp. In such cases, long acquisition time poses a limitation. It is, therefore, desirable to have a network analyzer with a substantially shorter acquisition time, capable of characterizing networks and devices in real time.

In some applications, network parameters vary over time in a manner, which precludes the use of conventional swept frequency network analyzers. Swept measurements incur penalty both in terms of acquisition time, and in terms of registration between measurements taken at the beginning and at the end of a sweep.

### SUMMARY OF INVENTION

According to a first aspect of the invention there is provided a real time network analyzer, comprising: a periodic sequence generator; a plurality of receivers comprising: a wideband sampling data converter; Fourier transform processor: and a network parameter calculating unit.

According to a second aspect there is provided a real time network analyzer, comprising at least one generator wherein the at least one generator producing a wideband periodic signal; a plurality of receivers comprising a wideband sampling data converter, a Fourier transform processor, and a network parameter calculating unit.

In an embodiment the wideband periodic signal spectrum covers all the frequency range of interest.

In an embodiment the wideband periodic signal is a multi-tone sequence.

In an embodiment the wideband sampling data converter is a subsampling data converter.

In an embodiment the wideband data converter comprises: a multiplier with a multi-tone sequence; a lowpass filter, and a narrow band sampling data converter.

According to a third aspect of the invention there is provided a method of reducing the bandwidth of the received baseband signals by using a multi-tone signal as local oscillator of the receiver frequency down-converter mixer.

According to a fourth aspect there is provided a real time network analyzer, comprising: a sequence generator, a plurality of receivers comprising a wideband sampling data converter, a correlator of the sampled data with a reference template; an impulse response extraction unit; a frequency response calculation unit; and a network parameter calculating unit.

In an embodiment, the receiver comprises a frequency down-converter mixer with a fixed “comb” multi-tone or a similar periodic sequence signal as its local oscillator, a narrow band sampling data converter, and a Fourier transform processor.

In an embodiment the network analyzer is a VNA.

According to a fifth aspect of the present invention there is provided a real time network analyzer, comprising: a sequence generator, a plurality of receivers comprising: a wideband sampling data converter, a correlator of the received sampled data with a reference template; an impulse response extraction unit; a frequency response calculation unit; and a network parameter calculating unit.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks, according to embodiments of the invention, could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein, are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The subject matter disclosed may best be understood by reference to the following detailed description when read with the accompanying drawings in which:

FIG. 1 is a timing diagram illustrating a method according to an embodiment of the present invention.

### DETAILED DESCRIPTION

An improved architecture for real-time analysis of network parameters is disclosed herein. In accordance with the description herein, examples include configurations ranging from thermal drift of amplifiers, to microwave imaging of moving objects, characterizing materials on conveyors, characterizing plasma buildup, and many more.

The methods and apparatus disclosed herein can be incorporated with components from network analyzer known in the art, such as a network analyzer described in U.S. Publication No. US-2015-0212129, the entire disclosure of which are incorporated herein by reference.

In accordance with embodiments, a continuous-wave (CW) signal source of a network analyzer is replaced with a multi-frequency signal source, preferably covering the entire frequency range of interest. The multi-frequency signal source preferably generates a “comb” of equally spaced carrier frequencies, resulting in a periodic time-domain signal preferably covering the entire frequency range of interest.

In some embodiments a method to generate a signal comprises using a digital waveform memory being periodically read out to a digital-to-analog converter (DAC). Optionally, the “comb” can be translated to a different center frequency by mixing the waveform with the output of a transmit auxiliary oscillator, using a regular or quadrature mixer.

On the receiver side, each of the plurality of receivers frequency down-converts the signal to a wideband baseband, (in case it was up-converted at the transmit stage) by mixing the received signal with the output of a receive auxiliary oscillator. The baseband signals are then digitized using, for example, analog-to-digital converters (ADCs) and converted to frequency domain using for example a Fourier transform. Usually a Fast Fourier Transform (FFT) algorithm is used, but other numerical methods such as “Chirped Z-transform” (CZT) may be used. The ratio of Fourier coefficients of the different received channels (e.g. reflection channels versus a reference channel) is then typically computed to obtain the relevant network parameters (e.g., reflection coefficients in this case) at each frequency.

Furthermore, the bandwidth of the received baseband signals may be reduced, thus allowing the use of a narrow band sampling data converter, by using a multi-tone signal as local oscillator (RXLO) of the receiver frequency down-converter mixer.

With the transmitted signal a multi-tone “comb” at sub-carrier spacing ΔF, one way to do so, is to use as a receiver local oscillator (RXLO) a similar multi-tone comb, with sub-carrier spacing ΔF−IF (as opposed to ΔF), and IF is an intermediate frequency, typically much smaller than ΔF. As a result, the n-th sub-carrier is down converted to frequency n·IF, i.e., IF sub-carrier spacing.

Specifically, in some cases, the transmitted signal may include a discrete comb at frequencies f₀+ΔF·n, n=0, 1, 2 . . . (where f₀ is the frequency of the transmit auxiliary oscillator) and RXLO is a scaled comb with frequencies at f₀−IF₀+(ΔF−IF)·n (where IF₀ is an offset frequency—can be null, implementation dependent). After the received mixer, the resulting down-converted signal yields tones at n·IF+IF₀.

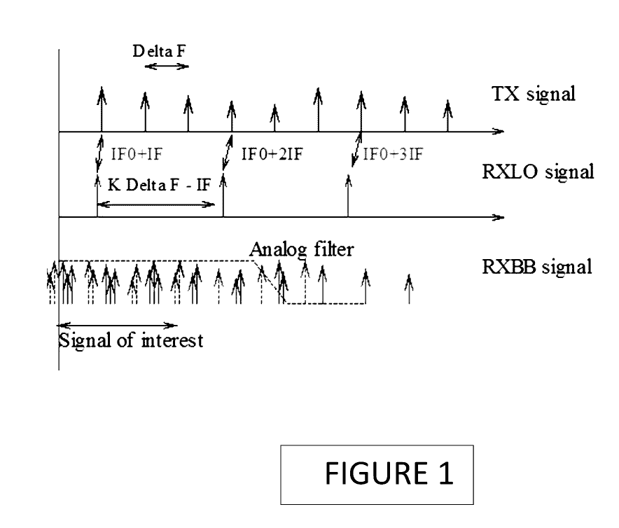

According to another embodiment to obtain a received baseband bandwidth reduction as illustrated in FIG. 1, the following method is utilized. Suppose the transmitted signal is a multi-tone comb with sub-carriers separated by ΔF, i.e., f₀+ΔF·n, n=0, 1, 2 . . . and only K of them can fit into the receiver's baseband bandwidth. The RXLO is chosen as a multi-tone comb signal with sub-carrier spacing ΔF·K—IF, i.e. f₀−IF₀+(ΔF·K−IF)·n. The first K sub-carriers of the received signal are demodulated by the first sub-carrier of the RXLO signal, i.e., to IF₀+m·ΔF (m=0, . . . , K−1). The next K sub-carriers are demodulated by the second RXLO sub-carrier, i.e., to IF₀+m·ΔF+IF thus a shift of IF with respect to the first set. The next K sub-carriers are demodulated by the third RXLO sub-carrier, i.e., to IF₀+m·ΔF+2·IF, thus a shift of 2IF with respect to the first set, and so on. This is illustrated in FIG. 1.

A single period of the received waveform is adequate to obtain the relevant network parameters. However, time permitting, multiple periods of the waveform may be averaged in order to improve the signal-to-noise ratio.

In some cases, the multi-tone signals are prone to have a large peak-to-average ratio, thus potentially harming the efficiency of the source drive amplifiers. It is therefore preferable to use well-designed waveforms having a small peak-to-average ratio. Such waveforms are well known in the art, e.g., chirp waveforms and complementary sequences. Furthermore, the proposed multi-tone signals may be compressed in a controlled or uncontrolled way (e.g., by the power amplifier) without affecting operation. This is because, even after compression, the signal remains periodic, implying that it is still a multi-tone signal, however with different amplitudes and phases, and perhaps some spectral growth. The amplitudes and phases generated by compression may be compensated for example by comparison with, or division by, the reference signal.

In some applications, a non-equally spaced transmitted multi-carrier or non-equally spaced receiver waveform (RXLO) may be used in order to reduce the effect of inter-modulations.

The multicarrier signals are prone to having large peak-to-average ratio, harming thus the efficiency of the source drive amplifiers. It is therefore preferable to use well-designed waveforms having small peak-to-average ratio. Such waveforms are well known in the art, e.g., chirp waveforms and complementary sequences.

The time period of the waveform representing the frequency comb can be adapted to the time scale of the variations that need to be characterized. For fast phenomena, a shorter waveform can be used. As a consequence, the frequency comb will have a lower density of spectral lines.

The transmit auxiliary oscillator and the receive auxiliary oscillator may have the same frequency or different frequencies, allowing different quadrature balance methods.

For example, frequency offset between the oscillators can be used to avoid folding upper sideband subcarriers and lower sideband subcarriers folding onto each other during reception. In embodiments described herein above in respect to exemplary of baseband reduction, the frequencies of the transmit and receive auxiliary oscillators were selected such as to achieve this goal.

### Correlation Based Receiver

In accordance with another embodiment, a method of processing a received signal may include obtaining the system impulse response by correlating the received waveform with a template waveform, where the transmitted waveform and the template waveform have a delta-function like correlation. It is noted that periodic waveforms can be used as well, advantageously, according to this configuration it is possible to work with nonperiodic waveforms or using a shorter fragment of a waveform for estimating the system response.

### Real Time Network Analyzer Instrument Configuration

Real Time Network Analyzer implementation will typically include bridges (“test set”) to allow simultaneous measurement of all the network parameters. Moreover, it will include multiple receiver channels to allow acquisition of all the network parameters in parallel, thus not harming the “real time” objective. All the regular network analyzer calibration procedures are applicable to the real-time network analyzer as well.

### Example Parameters

Modern data converters allow generating and sampling waveforms in the GHz range. This means that the instantaneous bandwidth of a real-time network analyzer based on the proposed method can be in a range of a few GHz. There is a recurring tradeoff between the sampling frequency and resolution. For example, use of a periodic waveform 100 nsec long will allow measurements over a 10 MHz grid. Use of a waveform 1 microsecond long will allow 1 MHz grid, at expense of time resolution.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only. The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A real time network analyzer, comprising:
at least one generator wherein the at least one generator producing a wideband periodic signal;
a plurality of receivers comprising:
a wideband sampling data converter,
a Fourier transform processor; and
a network parameter calculating unit.

2. The analyzer of claim 1, wherein the wideband periodic signal spectrum is covering an entire frequency range of interest.

3. The analyzer of claim 1, wherein the wideband periodic signal is a multi-tone sequence.

4. The analyzer of claim 1, wherein the wideband sampling data converter is a subsampling data converter.

5. The analyzer of claim 1, wherein the wideband data converter comprises: a multiplier with a multi-tone sequence;
a lowpass filter; and
a narrow band sampling data converter.

6. A method of reducing the bandwidth of the received baseband signals by using a multi-tone signal as a local oscillator of a receiver frequency down-converter mixer.

7. A real time network analyzer, comprising:
a sequence generator;
a plurality of receivers comprising:
a wideband sampling data converter,
a correlator of the sampled data with a reference template;
an impulse response extraction unit;
a frequency response calculation unit; and
a network parameter calculating unit.
